(19) United States
(12) Patent Application Publication
(10) Pub. No.: US 2021/0370539 A1
(43) Pub. Date: Dec. 2, 2021

(54) METHOD, PLANT AND STRUCTURE OF BLADE FOR CUTTING LOGS OF PAPER AND SIMILAR MATERIAL

(71) Applicant: Francesco ARRIGHI, Sant'Anna (IT)

(72) Inventor: Francesco ARRIGHI, Sant'Anna (IT)

(21) Appl. No.: 17/050,825

(22) PCT Filed: Apr. 29, 2019
(86) PCT No.: PCT/IB2019/053506

§ 371 Date: Oct. 26, 2020

(30) Foreign Application Priority Data
Apr. 27, 2018 (IN) 102018000004970

(51) Int. Cl. B26D 3/16; B26D 1/48; B26D 7/12; B26D 1/06

(52) U.S. Cl. CPC B26D 3/161; B26D 1/48; B26D 2001/006; B26D 1/06; B26D 7/12

(57) ABSTRACT

A method, a plant and a blade for cutting logs that provide a cutting region crossed by at least one log according to a conveying direction transversal to a cutting plane, and a blade having a longitudinal axis. The blade comprises a plane cutting portion and a connection portion connected thereto. The cutting portion has a cross section of minimum width, a cross section of maximum width and at least one cutting profile that extends obliquely between the cross section of minimum width and the cross section of maximum width, so that the cutting profile forms an angle with respect to the longitudinal axis. The cutting profile has a cutting height in a direction orthogonal to the longitudinal axis equal to at least the difference between the cross sections of maximum width and of minimum width. The connection portion has width less than or equal to the minimum width.

### FIELD OF THE INVENTION

The present invention relates to the field of paper converting, and more precisely it relates to a method for cut at a high speed logs of paper and similar material, for making toilet paper rolls, kitchen rolls, cleaning rolls for industrial use, stacks of wipers, napkins and the like.

The present invention relates, furthermore, to a cutting plant that carries out this method. Furthermore, it relates to a structure of blade used in this plant and for carrying out this method.

### BACKGROUND OF THE INVENTION

### Technical Problem

Transversal cutting machines are well known and commonly used to make rolls or stacks of paper, for example for use as toilet paper, kitchen rolls, tissue paper stacks and the like, which receive as input a log or logs of paper or similar material that have been preliminarily prepared upstream. With these machines it is possible to achieve very production rates.

In such transversal cutting machines, at least one log is normally arranged on step plane conveyors. Then, a part of the log to be cut is in turn kept still so that a sharp blade passes through the paper, thus cutting in turn the log into rolls or stacks or portions of the same length as a conveying step. More precisely, before each cutting reciprocation of the blade, the logs are shifted axially by a pitch that corresponds to a distance equal to the length of each roll or pack or portion to obtain. The logs are kept still only during the cut by a clamping device that makes it possible to avoid any misplacement during the cut, and instead allow the sliding of the log during the step-conveying phase.

Cutting machines of this type can be equipped with a circular blade, as described in US2008017003 or U.S. Pat. No. 5,315,907. These systems have the advantage of being very fast and allow very high production rate s, but also have drawbacks, among which the following:

impossibility to cut more than one certain number of logs in parallel to each cutting stroke, normally not more than four

the determine costs of the cutting plant very high, for the costs of both the blade, and the orbital driving mechanism thereof, as well as for frequent adjustments for compensating the reduction of diameter caused by the continuous sharpening, causing frequent changes of the blade;

they cause a cut which is not always orthogonal, and the higher is the diameter and the density of the log the more inaccurate is the cut, owing to the triangular section of the sharpened edge of the blade;

they cause high shear stresses on the paper, caused by the reaction of the clamping devices that must firmly contain the shear stresses transferred by the blade on the log, as well quick wear of the lame owing to the friction that heats the blade;

they require frequent maintenance, since the frequent sharpening operations consume quickly the useful sharpened profile of the blade;

they determine high power consumption, both for the high shear stresses and for the orbital reciprocation;

they are not easy to use, both for the orbital movement, and for the compensation of the cutting stroke caused by diameter reduction for frequent sharpening, as well as for complex settings that are each time different for each different kind of product, thus requiring also specialized training for the operators;

they present many causes of failure, owing to the many adjustments, complex mechanical drives and installed parts;

present high risk of fire, since the sharpening has to be necessarily carried out in zones that are close to the paths of the log, often made of tissue paper and then highly inflammable, also owing to the plentiful powder of paper that is present in the cutting zone;

they cause high development of heat, by friction of the blade with the log during the cut that can determine an “explosion” of the cutting profile;

they present high rate of danger for the operators, owing to the very sharp profile of the cutting edge which extends of all the boundary of the disc of the blade, which determines lack of easy gripping points for a blade change or blade maintenance;

they have high costs of operation, for many of the above-described reasons.

Blades with a helical profile also exist, as described in EP0555190, which however has had low practical use.

In a way more limited with respect to transversal cutting machines with circular blades, industrial transversal cutting machines with band saw have been used, with the band saw sharpened on one edge or on two edges, rotating on two flywheels rotatably mounted on a mobile reciprocating carriage, which determine the reciprocation of the band saw during a cutting stroke. The flywheels can be mounted on a mobile carriage that reciprocates horizontally, as described in KR101642488 (B1) or KR890003099 (B1), or on a mobile carriage that reciprocates vertically, as described in ITMI942062(A1). Other examples with band saw are known in EP1040895A2 and WO2008062488A1.

Such cutting systems with band saw have the advantage of having high precision of cut even with log of large diameter and density, as well as absence of danger of fire, since the blade can be sharpened far from the cutting zone. However, they have a plurality of drawbacks, among which the following:

a limited production rate, risks of hurting the operators both in occasion of the change of the blade, and when cleaning the machine from debris or when solving other operative conditions, risk of derailing of the band saw from the flywheels. Therefore, they are mainly used for cutting logs of medium-large diameters, such as industrial rolls, or large rolls for large dispensers of toilet paper.

Among the main limits of the application of the cutting machines with band saws, there is the slow reciprocating relative movement between the whole carriage with the flywheels and the paths on which the logs are conveyed.

It is therefore desirable a cutting system that achieves the high production rates of the circular blades and the high precision and the low costs of the band saws.

### SUMMARY OF THE INVENTION

An object of the present invention is then to provide a method for cutting logs of paper and similar material does not present the above identified drawbacks of both the circular blades and of the band saws.

Another object of the present invention is to provide a plant for cutting logs of paper and the like configured for carrying out such method and avoiding the above-identified drawbacks.

A further object of the present invention is to provide, a blade for cutting logs of paper and the like configured for working with the plant and according to the method and avoiding the above-identified drawbacks.

These and other objects are achieved by a method for cutting logs comprising the steps of:

prearranging at least one cutting region configured to be crossed by at least one log according to a conveying direction transversal to a cutting plane;

prearranging a blade having a longitudinal axis and comprising:

a plane cutting portion and a connection portion connected to the cutting portion;

said cutting portion having a cross section of minimum width, a cross section of maximum width and at least one cutting profile that extends obliquely between the cross section of minimum width, and the cross section of maximum width, so that the cutting profile forms an angle with respect to the longitudinal axis set between 1° and 60°, in particular between 1° and 30°, much more in particular, between 1° and 10°,

the cutting profile having a cutting height, in a direction that is orthogonal to the longitudinal axis, equal to at least the difference between the cross section of maximum width and the cross section of minimum width, and the connection portion having width less than or equal to the minimum width;

moving the blade parallel to the longitudinal axis so that the connection portion and the cutting portion cross in turn the cutting region and the cutting portion passes through the cutting region according to the cutting plane;

conveying the log, or each log, on a respective cutting cradle into the cutting region, the log having a height less than the cutting height so that the cutting profile that extends obliquely cuts the log during the movement in contact with the log and causes a cut of the log making cut portions having a same length as a predetermined conveying length.

This way, the shear force has a direction in minimum part orthogonal to the log, and mainly parallel to a speed of the longitudinal axis of the blade, such that the resulting shear force is parallel to the oblique sharp profile of the blade, which penetrates gradually into the log, determining a precise and clean cut at an optimal speed of the blade with respect to the log.

This way, a plurality of advantages derive with respect to the two cutting techniques of disc blade and band saw, as described above, with a very high cutting quality like the band saw technology and very high production rate like the disc blade technology. In fact, the gradual penetration of the blade allows minimum shear stresses and minimum reactions on the blade for length unit of the cutting profile, and then a high speed of the band of the blade can be achieved, in addition to a low power installed, as well as possibility of arranging even 8 log feeding cradle channels, or more, for each cutting region, as well as the possibility to cut, with a same passage the blade, even logs of different diameter.

The absence of reciprocating parts between logs and blade and a very low number of accessories allow limited costs, rapidity of production and installation of the plant that carries out the method, as well as minimum maintenance, in addition to simplicity of use and setting, as well as safety of manipulation of the blade in case of replacement or cleaning.

Furthermore, the blade has very long duration, since the consumption for sharpening of the blade does not require any setting adjustments, and does not cause a reduction in width or thickness of the blade, but simply a different ratio between the length of the cutting portion and the length of the connection portion. The blade can also be chosen very thin, for example even a few tenth of mm for soft products, up to avoiding the need of sharpening.

Advantageously, the blade can be selected from the group consisting of:

a blade with a cutting portion having a single cutting profile, for example that can be used by arranging, for example, the blade above a plurality of cutting cradles parallel to each other, for example eight cradles or more and cutting profile oriented towards below.

a blade with a cutting portion having two cutting profiles opposite to each other with respect to the longitudinal axis, in the cutting region, the logs being fed opposite to each other with respect to the longitudinal axis so that the logs are cut from both the respective cutting profiles, for example arranging for each blade two cradles at the two respective opposite sides of the blade, so that each cutting profile cuts a respective log, with the possibility of easily cutting industrial rolls or jumbo rolls, with high precision and rapidity;

a blade with the cutting portion having two cutting profiles arranged at a same side with respect to the longitudinal axis, the two cutting profiles cutting the log when the blade carries out a cutting movement in two respective opposite directions, with possibility of making a cut with a reciprocating axial movement of the blade but without reciprocating moving parts orthogonal to the axis, with low installation costs and minimum size, as well as stability of the band against derailing;

a combination thereof, for example a blade with two cutting profiles arranged at a same side with respect to the longitudinal axis and duplicated on another opposite profile with respect to the longitudinal axis, for example that can be used with alternated movement in a vertical plane for carrying out the cut on two cradle channels both with movement towards below that towards the above of the blade.

In an advantageous variated method, the blade can be selected among:

a blade where the plane cutting portion and the connection portion connected to the cutting portion consist of a single plane band, selected as a band continuously looped about at least two flywheels that determine either a continuous movement, or a band having a reciprocating movement, both solutions allowing maximum lightness of the blade, obtainable with a single band sheet;

a blade where the plane cutting portion comprises a plane band and the connection portion is a connecting element connected to the plane cutting portion, and where the blade can be selected from the group consisting of: a continuous blade looped around about at least two flywheels that provide a continuous movement, a discontinuous blade having reciprocating movement, and where the connection portion can be selected from the group consisting of: a band portion, a chain portion, a rope portion, a belt portion.

If the plane cutting portion comprises a plane band and the connection portion is a connecting element connected to the plane cutting portion, the connection portion can be selected from the group consisting of:

a continuous element, which then provides an overlapped portion with the plane cutting portion;

a discontinuous element, consisting of a connection portion that is discontinued after the connection with the plane cutting portion.

In an alternative implementation of the method, the blade comprises a conveying portion having a larger width than the cutting portion, the conveying portion defining at least one elongated hole on which both the at least one cutting profile and the connection portion are facing, the elongated hole defined by a connection belt which extends opposite to the at least one cutting profile.

This solution, which can be provided for each of the embodiments above described, both with a single cutting profile and with more than one cutting profiles, both with continuous or discontinuous connection portion, determines a band with fixed width and the cutting profile only in the cutting portion, allowing to convey the blade very steadily and quickly, owing to the presence of the connection belt.

In case of a conveying portion having a larger width than the plane cutting portion, the elongated hole can be a first elongated hole and the plane cutting portion provides a second elongated hole, for lightening the blade. In this case the plane cutting portion provides a band portion that has a first end connected to the first connection belt and a second end that is connected to a second connection belt, and extends obliquely between the two connection belts, the band portion extending obliquely between the first connection belt and the second connection belt, in order to have said cutting profile facing towards the first connection belt. In a particular embodiment, the band portion may also have a cutting profile facing towards the second connection belt, in case of reciprocating movement of the blade, in this case at least one further log feeding cradle provided in the second elongated hole.

Preferably, a conveying solution is selected from the group consisting of:

a stepped conveying of the log, or of each log, on a respective cutting cradle into the cutting region, the stepped conveying being carried out when the connection portion moves in the cutting region and being stopped when the connection portion moves in the cutting region, so that the cutting profile that extends obliquely cuts the log obtaining cut portions for a length corresponding to one conveying step;

a continuous conveying of the log, or each log, according to a conveying direction on a respective cutting cradle into the cutting region, in the cutting region a conveying device being provided that causes a bending action in the blade conveying direction between a first position and a second position, the conveying device causing the bending in the conveying direction between the first position and the second position in a way that is synchronous to the continuous conveying of the log, or each log, when the cutting portion moves in the cutting region, so that the cutting profile that extends obliquely cuts the log obtaining cut portions having a same length as a predetermined conveying length, and the conveying device causing the bending in a direction that is opposite to the conveying direction from the second position to the first position when the connection portion moves in the cutting region, so that the connection portion moves next to the log without impeding the continuous conveying of the log.

The solution of stepped conveying of the log, even if it is a traditional stepped log feeding system, can permit an increase of the number of cradles, for example up to 8, or more, and a subsequent evacuation of a corresponding number of cut portions. The stepped movement can be triggered simply with a measurement, using for example an optical or magnetic sensor of the movement of the front end of the cut portion at a predetermined point, and then computing the time for transit of the connection portion.

Instead, the solution of continuous conveying has the advantage of reduced dynamic stresses for the stepped advancing, with lower wear, lower energy consumption, in addition to higher production rates, avoiding the idle times of stop, wait and start of the log. In fact, the movement of moving back the blade to the first position and the transit of the connection portion overlap the time of continuous moving of the log, allowing even very high speed, and production rates of the cut portions much higher than a maximum available with respect to a stepped movement.

In case of continuous conveying and of a conveying device in the cutting region that causes a bending of the blade in the conveying direction, a system can be provided for tensioning the blade, selected from the group consisting of: a spring loaded blade tensioning device and a mechanism of synchronous shifting of at least one axis of the pulley drums, either motorized or idle, that convey the blade.

In some possible exemplary embodiments, to avoid the need of a blade tensioning device, and in order to double the production rate, two respective opposite conveying devices can be provided, similar to what above described, which move integrally in an alternated way, but according to two opposite sides of the blade path. This way, the two conveying devices, causing a bending of the blade in one or in the other conveying direction, are set to cut according to phases opposite to each other. In this way, the tension of the blade does not require further compensations, since the blade is constantly tensioned. Furthermore, the production rate is doubled.

Further sides of the blade and further dispositions of the cradles of the log can be implemented by the skilled person, and preferably even with further systems when the blade extends on a wide working area, for example polygonal with more than four sides.

In a possible implementation of the method, the blade is looped around a plurality of flywheels or pulleys arranged in polygonal layout, in particular quadrilateral, wherein on one edge of a polygonal path a sharpening device is provided, and wherein on at least another edge of the polygonal path at least one cutting region is provided, in particular the cutting region arranged downstream of a log storage region produced through a log production line comprising at least one rewinding machine, or an interfolding machine, or a machine for stacking packs of folded sheets. Such solution makes it possible to eliminate bottleneck delays due to cutting waiting times, arranging a cutting region at each edge of the blade polygonal path, or cutting, with a single blade, logs exiting from two different production lines.

In particular, the cutting region is configured in a way selected from the group consisting of:

a cutting region arranged upstream of a downhill conveying path along which cut portions of log move, with a first side of polygon crossing the cutting region upstream of the downhill conveying path, and a second side of polygon opposite to the first side and extending above the downhill conveying path so that the blade does not impede the cut portions of log;

a cutting region and a log conveying path upstream of the cutting region, wherein a first side of polygon consisting of the blade crosses the cutting region, and a second side of polygon consisting of the blade is opposite to the first edge and extends upstream of the conveying path so that the blade does not impede cut log portions;

a cutting region and two log conveying paths upstream of the cutting region, wherein a first and a second side of polygon consisting of the blade cross the log conveying paths in two respective cutting regions in order to cut the log coming from the two conveying paths, and a third side of polygon consisting of the blade passing above two respective downhill conveying paths of the cut portions of log so that the blade does not impede them;

a cutting region wherein the polygonal blade arrangement is in a vertical plane and the blade has at least one couple of cutting profiles opposite to the longitudinal axis, upstream of the cutting region a conveying path of at least two logs being provided so that the at least two logs are located at opposite sides with respect to the blade cutting plane.

All the above-described solutions, which are some among the possible applications of the cutting layout with the method according to the invention, allow increasing remarkably the production rate of existing lines or permit a new production line design with very high production rate.

Advantageously, in the cutting region a pressing element is provided selected from the group consisting of:

a pressing element comprising two conveyor belts facing each other that move in the conveying direction, for carrying out the advancing movement, and in a direction that is orthogonal to the conveying direction, for carrying out a blocking stroke of the log simultaneously to the movement of the cutting portion in the cutting plane, an height adjustment mechanism of the conveyor belts being provided, in order to adjust a rest position of the conveyor belts before carrying out the blocking stroke and adapting to different diameters of the log;

a pressing element comprising an upper pressing member having at least one couple of plane upper pressing plates, configured to contact a respective generatrix of the log, the upper pressing member carrying out a blocking movement in a direction that is orthogonal to the conveying direction according to a blocking stroke that is effected during the movement of the cutting portion in the cutting plane, there being provided an height adjustment mechanism of the upper pressing member, in order to adjust a rest position of the plane pressing plates before carrying out the blocking stroke and then to adjust to different diameters of the log.

Such two solutions for blocking the log, which are only exemplary solutions among other blocking possibilities, allow to block the log with simplicity and rapidity for permitting a stop and start of the stepped movement, since the method according to the invention allows a cut without that high shear stresses are generated, and then without that high force components are generated that would require a stronger block. This avoids of leave undesired markings or deformations on the cut portions. The solution with conveyor belts opposite is also suitable to be used in case of continuous movement of the log.

Owing to the very low shear stresses on the log, it is also possible that there is no need of blocking the log, and the shape of the cradle is configured to keep the log, by a simple positive engagement or by the aid of suction holes or air jets.

Preferably, a sharpening step is provided of the blade, carried out only on the cutting profile of the cutting portion and not on the connection portion, in particular the sharpening step being selected from the group consisting of:

sharpening by a couple of abrasive sharpening sticks arranged slanted and opposite to each other;

sharpening by a sharpening knob mounted to an oscillating arm or swinging arm, configured to oscillate under the push of the knob in order to follow the cutting profile during the movement of the cutting portion,

sharpening by an elongated abrasive strip mounted to a support arranged laterally, so that the cutting profile contacts with an own side face against the strip, and so that different portions of the cutting profile contact different portions of the strip.

The above-described sharpening systems allow an easy sharpening action that is carried out only on the cutting profile, and can be mounted at a sufficient distance from the cutting region that avoids risks of fire.

According to another aspect of the invention, a plant is provided for cutting logs characterized in that it is configured for carrying out the method as above, reaching the same advantages.

According to another aspect of the invention, a blade is provided for cutting logs characterized in that it is configured for carrying out the method and working in the plant of which above reaching the same advantages.

### BRIEF DESCRIPTION OF THE DRAWINGS

The invention will be now shown with the following description of its exemplary embodiments, exemplifying but not limitative, with reference to the attached drawings in which:

FIGS. 1-4 show four successive cutting steps of the method according to the invention;

FIGS. 5-10 show exemplary embodiments of a cutting blade according to the invention;

FIGS. 11-11A, 12, 13 and 13A show exemplary embodiments of a blade cutting path with synchronous movement of the blade and continuous movement of the log;

FIGS. 14-19 show possible layouts of a blade path connected to the method according to the invention provided at the exit of production lines of logs;

FIGS. 20-23 show two possible exemplary embodiments of alternated cut;

FIGS. 24 and 25 show two possible exemplary embodiments of clamping devices used in combination with the method according to the invention;

FIGS. 26-29 show exemplary embodiments of sharpening systems connected to the method according to the invention.

### DESCRIPTION OF PREFERRED EXEMPLARY EMBODIMENTS

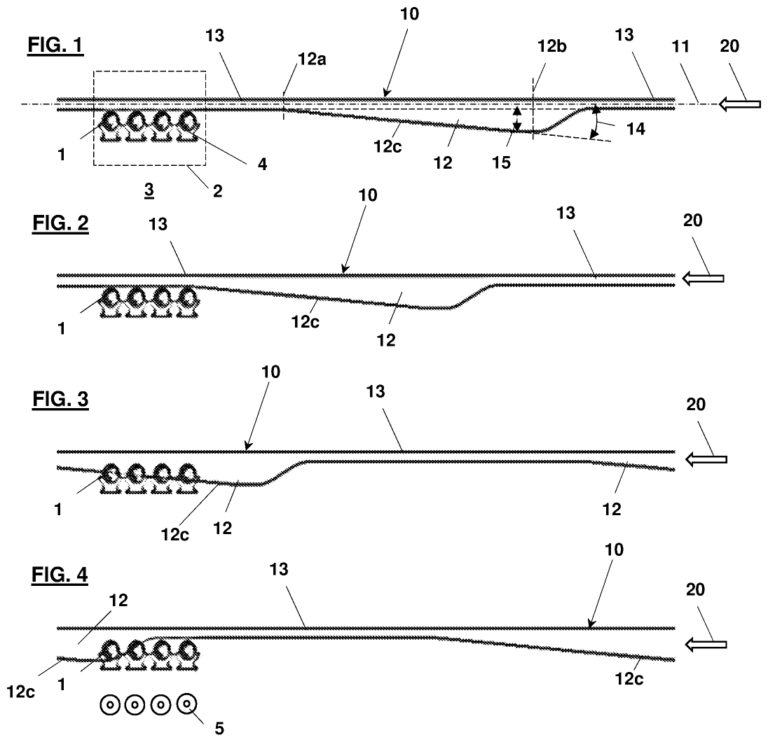

With reference to FIGS. 1-4 a method according to the invention for cutting a log 1 comprises the steps of:

prearranging at least one cutting region 2 configured to be crossed by at least one log 1 according to a conveying direction transversal to a cutting plane 3, coincident or parallel to the rectangle indicated as 2 in FIG. 1 with a dashed line;

prearranging a blade 10 having a longitudinal axis 11 and comprising:

a plane cutting portion 12 and a connection portion 13 connected to the cutting portion 12;

the cutting portion 12 having a cross section of minimum width 12a, a cross section of maximum width 12b and at least one cutting profile 12c that extends obliquely between the cross section of minimum width 12a, and the cross section of maximum width 12b, so that the cutting profile 12c forms an angle with respect to the longitudinal axis set between 1° and 60°, in particular between 1° and 30°, much more in particular, between 1° and 10°, for example between 1 and 8°;

the cutting profile 12c has a cutting height 15 in a direction that is orthogonal to the longitudinal axis 11 equal to at least the difference between the cross section of maximum width 12b and the cross section of minimum width 12a, and the connection portion 13 has width less than or equal to the minimum width 12a;

causing a movement 20 of the blade 10 parallel to the longitudinal axis 11, so that the connection portion 13 and the cutting portion 12 cross in turn the cutting region 2 and the cutting portion 12 cross the cutting region 2 according to the cutting plane 3;

conveying the log, or each log, 1, on a respective cutting cradle 4 in the cutting region 2, the or each log 1 having a height less than the cutting height 15 so that the cutting profile 12c that extends obliquely cuts the log 1 when advancing, by contacting the log and then cutting the log, in order to obtain cut portions 5 having a same length as a predetermined conveying length.

In case of logs 1 of large diameter, in a way not shown but easily implemented by a skilled person, it is also possible that the cradle 4 causes a rotation of the log 1 about itself when the cutting profile 12c passes above the cradle 4. In this case, the cutting height 15 can be equal to half the diameter of the log 1, or equal to the difference between the radius of the log 1 and the radius of the core of the log 1.

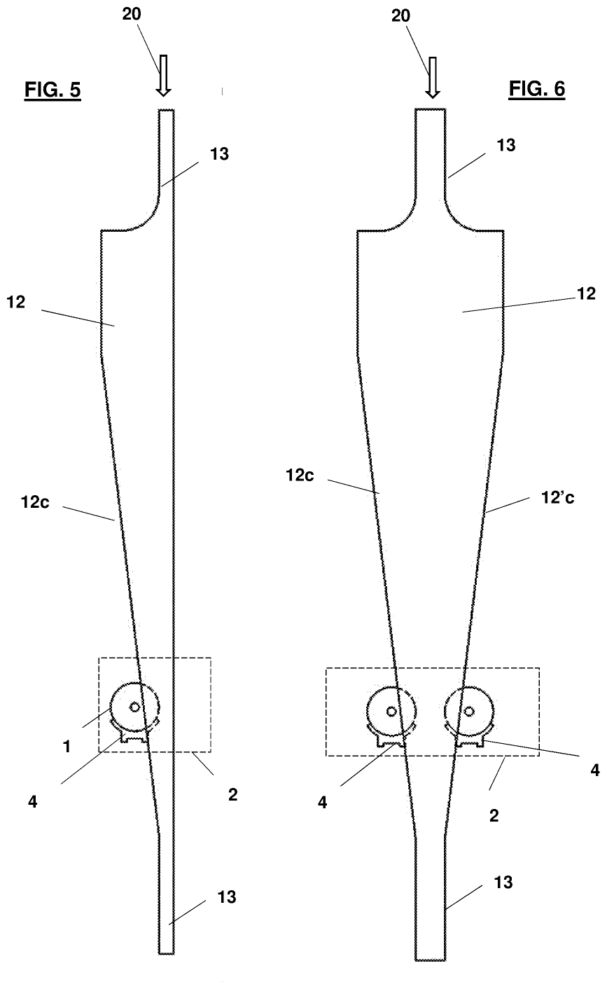

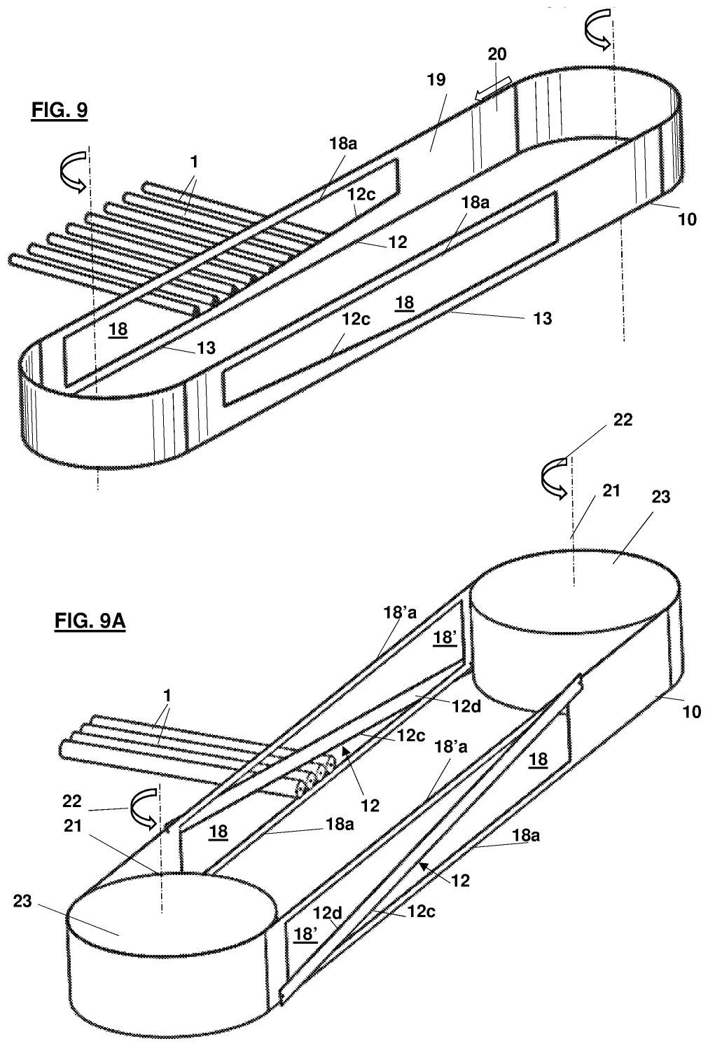

With reference to FIG. 5, the blade can have the cutting portion 12 having a single cutting profile 12c (FIG. 5). In the cutting region logs 1 can be fed, which are arranged as shown in FIG. 5 or as in FIGS. 1-4, or arranged in a similar way to FIG. 9 (as described hereinafter) aligned in respective cradles 4, providing up to, for example, eight cradles parallel to each other, also that they can be each cradle 4 with log of different diameter, or of different material.

Alternatively, the blade can have cutting portion 12 having two cutting profiles 12c,12′c opposite to each other with respect to the longitudinal axis 11 (FIG. 6). This way, in the cutting region 2 logs 1 can be fed opposite to each other with respect to the longitudinal axis 11, so that the logs are cut from both the respective cutting profiles 12c,12′c. Such solution can be particularly suited for industrial rolls or jumbo rolls.

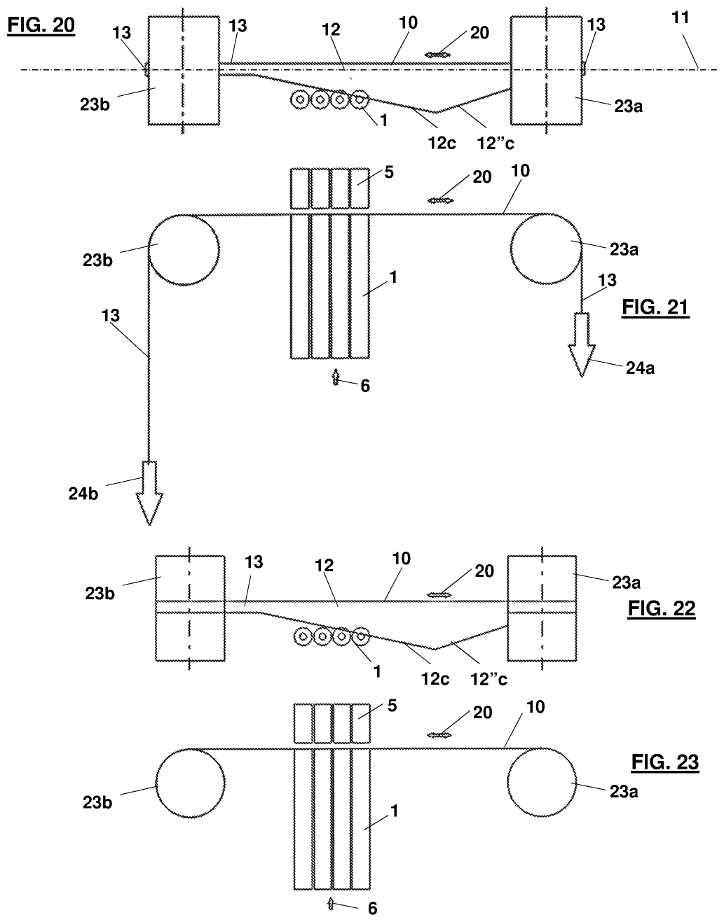

In a further solution, as shown in FIGS. 20-23, the blade can have the cutting portion 12 with two cutting profiles 12c,12″c, arranged at a same side with respect to the longitudinal axis 11, the two cutting profiles 12c,12″c cutting the log 1 (arranged on cradles not shown, for example similar to the cradles 4 of FIGS. 1-4) when the blade 12 carries out the movement in respective opposite directions.

It is also possible, in a way not shown but easily implemented by a skilled person, to combine the above described profiles, for example a blade with two cutting profiles arranged at a same side with respect to the longitudinal axis as shown in FIGS. 20 and 22 and duplicated on the other part of the longitudinal axis as shown in FIG. 6. Such blade can for example be used with alternated movement in a vertical plane for carrying out the cut on two cradles both with movement of the blade towards below and towards the above.

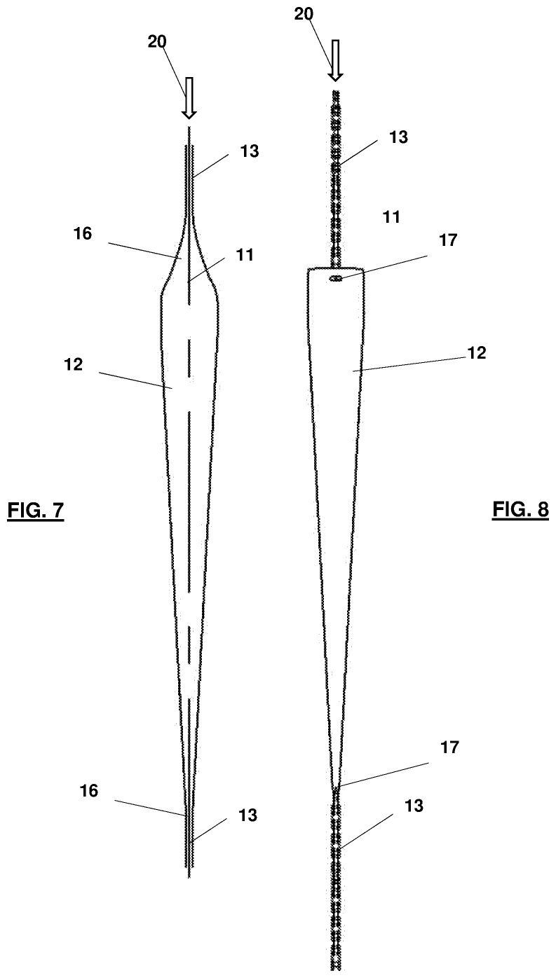

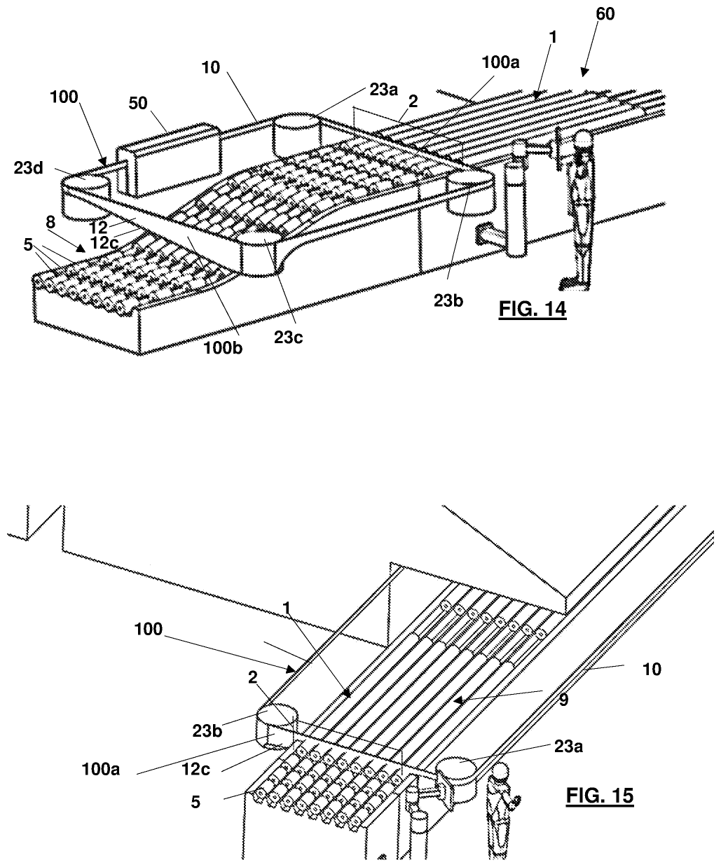

As shown in FIGS. 7 and 8, the blade can also have (FIG. 7) a plane cutting portion 12 and a connection portion 13 connected to the cutting portion 12 consisting of a single plane band, which can be a band continuously looped about at least two flywheels (for example implemented by a skilled person as the flywheels 23a,23b of the FIGS. 14-19), which provide a continuous movement, or a reciprocating band, as that of FIGS. 20-23. Such solution of continuous band is particularly advantageous for simplicity for making the blade, which can be a simple band of a shaped sheet, and sharpened only on the cutting profile, even very thin (a few tenth of mm) in such a way that it does not need to be sharpened further.

Alternatively, a blade (FIG. 8) can be provided, where the plane cutting portion 12 comprises a plane band 12 and the connection portion 13 is a connecting element connected to the plane cutting portion, and where the blade can be selected from the group consisting of: a continuous blade looped about at least two flywheels that provide a continuous movement, a discontinuous blade having reciprocating movement, and where the connection portion 13 can be selected from the group consisting of: a band portion, a chain portion, a rope portion, a belt portion. The connection portion 13 can be connected to the cutting portion for example by a link 17, or the belt, chain, rope, in addition to form the connection portion 13, can also extend integrally along the cutting portion 12, to ensure continuity of traction, through pulleys, gears, spools, not shown, which provide a torque and guide the path of the cut or the blade path. Such solution makes it possible to replace easily the cutting portion without to replace also the connection portion.

The examples of FIGS. 7 and 8 can be fixed at a desired blade as above described or as described hereinafter, both with only one cutting profile that with two cutting profiles, in a way easily implemented by a skilled person.

In case of the example of FIG. 8, in a way easily implemented by a skilled person, the connection portion can be chosen as a discontinuous element, consisting of connecting portions 13 that is are discontinued at the connections 17 with the plane cutting portion, or alternatively as a continuous element 13 that extends also between the connections 17 of the plane cutting portion 12 parallel to it.

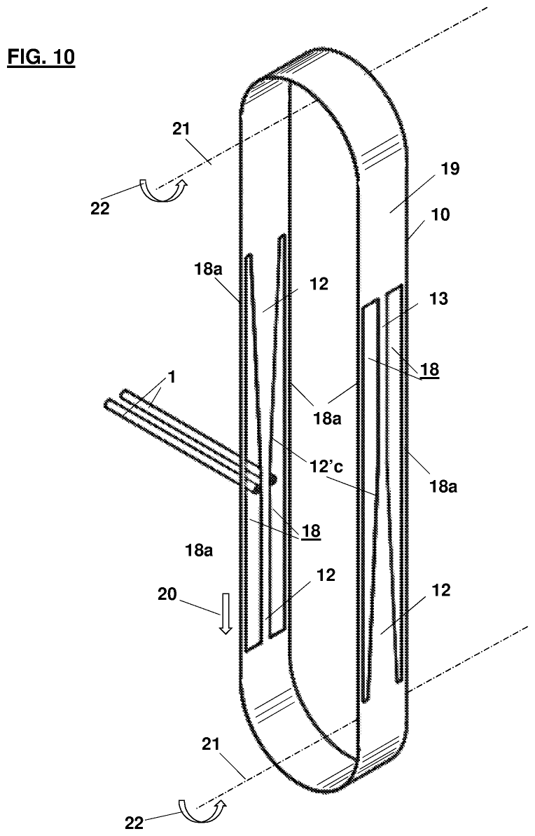

Alternatively, or in addition, as shown in FIGS. 9, 9A and 10, for cutting logs 1 the blade can comprise a conveying portion 19 having a larger width than the cutting portion, the conveying portion 19 defining at least one elongated hole 18 on which the at least one cutting profile 12c and the connection portion face, the elongated hole defined by a connection belt 18a that extends opposite to at least one cutting profile 12c. This way, both with a single cutting profile 12c (FIG. 9) as well as with more cutting profiles 12c,12′c (FIG. 10) for each connection portion 13, on the one hand a band 19 is obtained with fixed width even if maintaining a cutting profile 12c or 12c,12′c in the cutting portion 12 with adjustable cross section, allowing to convey the blade 10 in a way that is very steady and quick, owing to the presence of the connection belt 18a.

The conveying the log 1, or each log 1, on a respective cutting cradle 4 in the cutting region 2, can be made stepwise, each step being carried out when in the cutting region 2 the connection portion 13 is moved, and is then stopped when in the cutting region 2 the cutting portion 12 moves, so that the cutting profile 12c that extends obliquely cuts the log 1 obtaining cut portions 5 for a length corresponding to one step.

In the possible embodiment of FIG. 9A the cutting portion 12 is arranged in turn in an elongated hole, with an elongated hole 18′, which allows lightening the cutting portion 12 same. In particular, the elongated hole 18 can be a first elongated hole and the plane cutting portion 12 provides a second lightening elongated hole 18′. In this case, the plane cutting portion 12 provides a band portion 12d that has a first end 12′d connected to the first connection belt 18a and a second end 12″d that is connected to a second connection belt 18′a, the band portion 12d extending obliquely between the first connection belt 18a and the second connection belt 18′a, in order to have said cutting profile 12c facing towards the first connection belt 18a. In a particular production configuration, the band portion may also have a cutting profile facing towards the second connection belt, in case of reciprocating movement of the blade, the band portion extending obliquely between the first connection belt and the second connection belt.

In a specific example of an exemplary embodiment of FIG. 9A, not shown but easily implemented by a skilled person, the band portion 12d may also have a cutting profile facing towards the second connection belt 18′a, in case of reciprocating movement of the blade, in this case at least one further cradle can be provided, or feeding logs in the second elongated hole 18′.

Also the solutions of FIGS. 9, 9A, 10 can provide the possible increase of the number of cradles, for example up to eight cradles, or more, and the subsequent evacuation of a corresponding number of cut portions (see for example the layout of FIGS. 14-17).

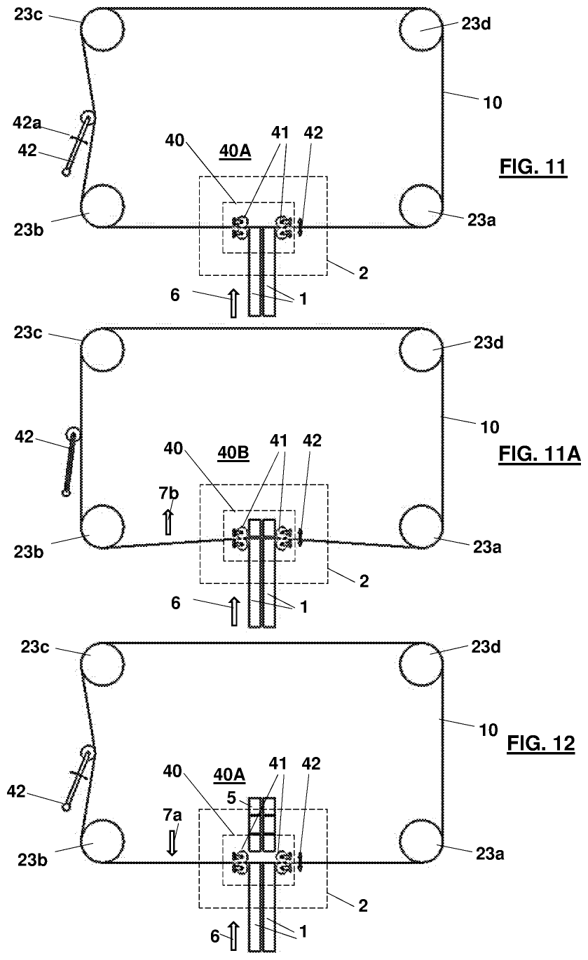

Alternatively to what above defined, the conveying of log 1 can be continuous (FIGS. 11-13). The continuous conveying can be made according to a conveying direction 6 in FIGS. 11, 11A and 12, or in two opposite directions for conveying two separate series of log 1, as described hereinafter.

With reference to FIGS. 11,11A, on each cutting cradle of logs 1 in the cutting region 2, by using a preferred exemplary embodiment of the blade 10 as above described, in order to avoid interferences with the cutting portion 13, in the cutting region 2, a conveying device 40 can be provided, for example consisting of small rollers 41 that roll on the blade 10 and that move integrally in an alternated way according to arrow 42. This way, the conveying device 40 causes a bending of blade 10 in the conveying direction 6 between a first position 40A and a second position 40B. In this bending, the tension of the blade is for example compensated by a blade tensioner 42, which can oscillate according to an arrow 42a.

According to this exemplary embodiment, when the conveying device 40 causes the bending in the direction 7b in the same conveying direction 6 from the first position 40A to the second position 40B (FIG. 11A), this bending is carried out with a movement synchronous to the continuous conveying of the log 1 in the direction 6, and this synchronous movement is carried out when in the cutting region 2 the cutting portion 12 moves, so that the cutting profile 12c that extends obliquely, cuts the log 1 obtaining cut portions 5 having a same length as a predetermined conveying length.

Instead, with reference to FIG. 1,2, the conveying device 40 can cause the bending in an opposite direction 7a to the conveying direction 6 from the second position 40B to the first position 40A when in the cutting region 2 the connection portion 13 moves, so that the connection portion moves next to the log 1 without avoid the continuous conveying of the log 1. Such movement 7a can be made in the quickest possible way, for increasing the production rate and the need of a connection portion 13 as short as possible, while the pitch of the cut is determined by the combination between the speeds of movement according to arrows 6 and 7a.

In these exemplary embodiments with continuous movement of the log 1, alternatively to a blade tensioner, the bending of blade 10 caused by the variation of position of the conveying device 40 can be compensated, in a way not shown but easily implemented by a skilled person, with the movement of at least one, or both the flywheels 23a, 23b, or other flywheels arranged for rotating the blade 10, in synchronism with the movement of the conveying device 40. In this case, the drums or the flywheels should be mounted to a support whose axis can move parallel to itself.

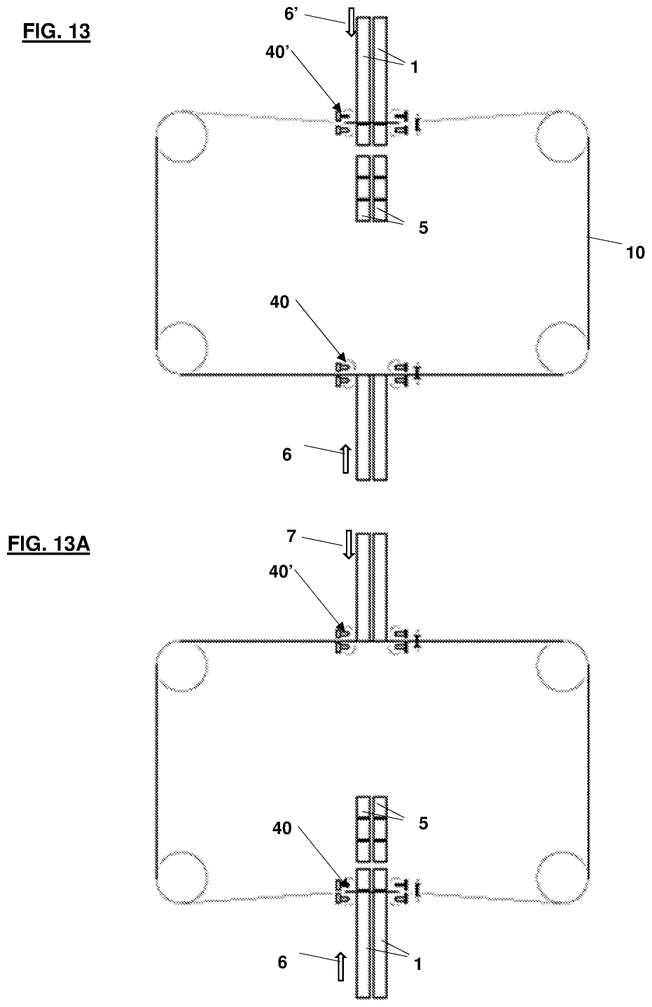

With reference to FIGS. 13 and 13A, in a possible exemplary embodiment of the two solutions of FIG. 11, 11A and 12, in order to avoid the need of a blade tensioner, and to double the production rate, two respective conveying devices can be provided 40, 40′, similar to that above described, that move integrally in an alternated way, but according to two opposite phases shown respectively in FIG. 13A and 13. This way, the two conveying devices 40, 40′ cause a bending of the blade 10 in the conveying direction 6 or in the conveying direction 6′ between the two above described positions, or in a similar way to that described in FIG. 12, provided according to phases opposite to each other. In this bending, the tension of the blade 10 does not require further compensations, since the blade is fixedly tensioned. Furthermore, the production rate is doubled. Further sides of the blade 10 and further dispositions of the cradles of the logs 1 can be implemented by the skilled person, and preferably even with further systems 40 when the blade 10 extends on a wide surface, for example polygonal with more than four sides.

With reference to the figures from 14 to 19, in possible production layouts, the blade 10 is looped around a plurality of flywheels or pulleys 23a,23b,23c,23d arranged as a polygon 100, in particular a quadrilateral, wherein, on an side of polygon a sharpening device is provided 50, and wherein on at least another side 100a of polygon at least one cutting region is provided 2. In particular, the cutting region 2 is located downstream of a storage region 60 of log ready to be cut, in turn, downstream of a production line of paper material comprising at least one production machine, for example a rewinding machine, or an interfolding machine, or a machine for stacking packages of folded sheets. Other machines can be unwinding, transversal cutting, gluing machines, etc., as well known in plants of paper converting.

In a first possible exemplifying embodiment (FIG. 14), downstream of the cutting region 2 a downhill conveying path 8 is provided along which cut portions 5 of the logs move. A first side 100a of polygon 100 of the path of blade 10 crosses the cutting region 2 upstream of the downhill conveying path 8, and a second side 100b of the polygon consisting of the path of blade 10 is opposite to the first side 100a and extends above the downhill conveying path 8 so that the blade 10 has the cutting edge 12 with the cutting profile 12c that do does not impede the cut portions of log 5, whereas when the cutting edge 12 with the cutting profile 12c passes through the side 100a of polygon 100, cuts the log 1 into portions 5. Such solution allows a very high production rate.

Another alternative layout shown in FIG. 15 provides upstream of the cutting region 2 a conveying path 9 of log 1, for example providing up to eight cradles of log 1 or even more. In this layout a first side 100a of polygon 100 of the blade path, consisting of the blade 10 and of the drums or pulleys 23a,23b, etc., crosses the cutting region 2 so that the cutting profile 12c cuts them into rolls 5, and other sides of polygon 100 extend upstream of and at the sides of the conveying path 9, so that the blade 10 does not impede cut portions of log 1 . The length of the sides of polygon 100 does not affect the efficiency of the method, since the angle of the cutting portion 10 can be also of a few degrees, up to 1 degree, and the speed 20 of the blade (FIG. 1-4) can be also of hundreds metres per minute.

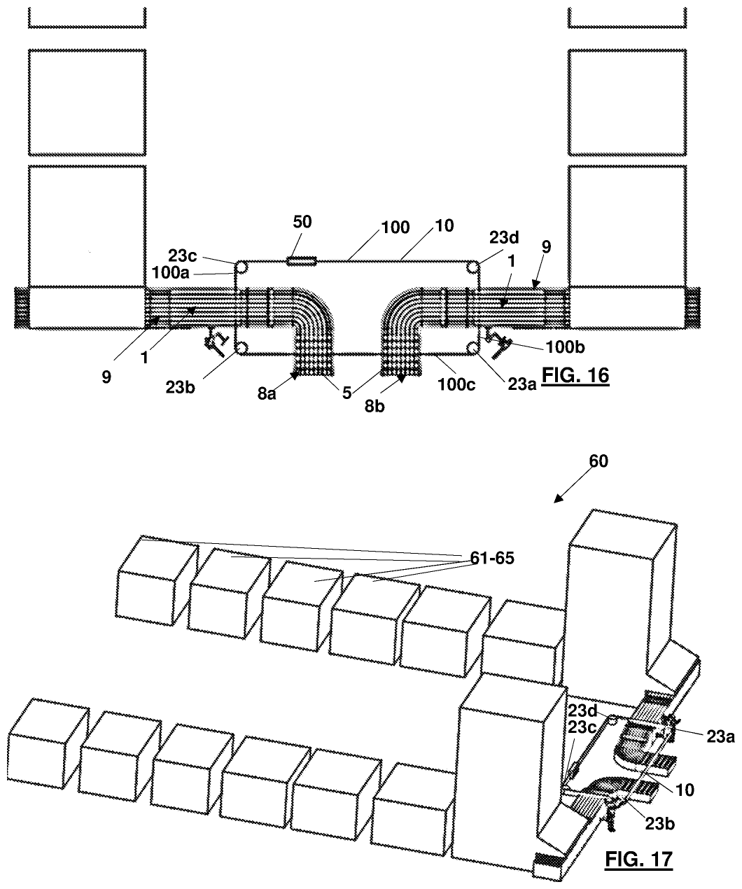

In a further layout shown in FIGS. 16 and 17, there are provided two cutting regions 2 and two conveying paths 9 of logs upstream of the cutting region, wherein a first and a second side 100a and 100b of polygon 100 provide blade 10 crossing the conveying paths 9 of log 1 in two respective cutting regions, in order to cut the log coming from the two conveying paths, and a third side 100c of polygon 100 passes above two respective paths of downhill evacuation 8a,8b of cut portions, so that the blade 10 does not impede respective cut portions of log 1. Such solution allows, with a single blade 10, a production rate doubled with respect to FIG. 14 or 15, with up to 16 logs (or more) cut by a single passage of blade 100. Obviously, other similar layouts and with a production rate even higher can be provided similarly, with a polygon with different shape and different size, but easily obtainable by a skilled person.

With reference to all these exemplary embodiments, with references 60 and 61-65 a production line of paper material is shown comprising at least one machine for paper converting, for example a rewinding machine, or an interfolding machine, or a machine for stacking packages of folded sheets. Other machines can be unwinding machines, transversal web cutting machines, gluing machines, etc., as well known in paper converting plants.

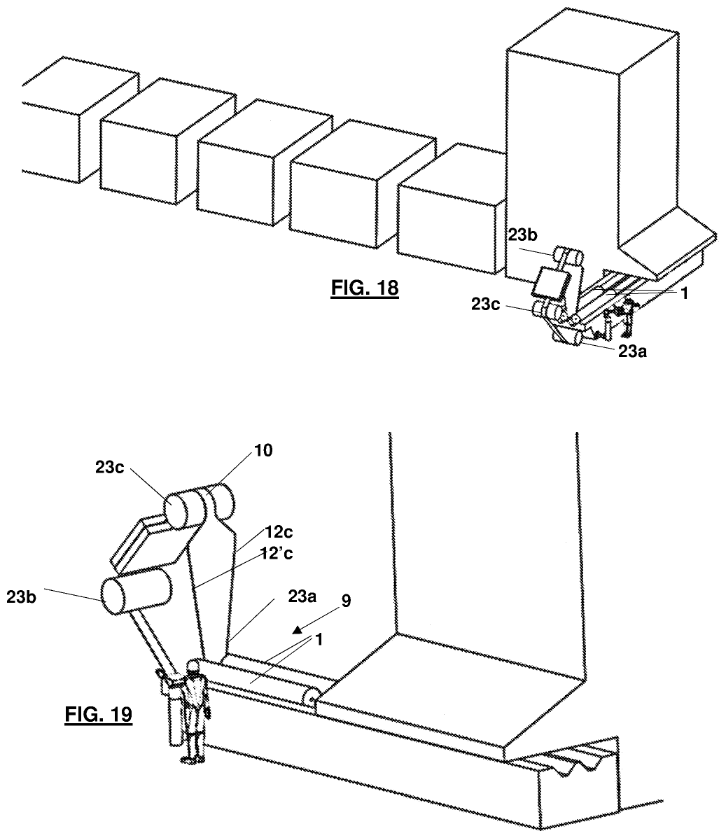

With reference to the FIGS. 18 and 19, a cutting region 2 can be provided wherein polygon 100 is arranged in a vertical plane and the blade 10 has at least one couple of cutting profiles 12c,12′c opposite to the longitudinal axis (as described for FIGS. 6-9). Upstream of the cutting region 2 there being provided a conveying path 9 of at least two logs 1, in a way in which they are located at opposite sides with respect to the blade 10 in the cutting plane. Such solution is particularly suitable to cut industrial rolls very thick and jumbo rolls.

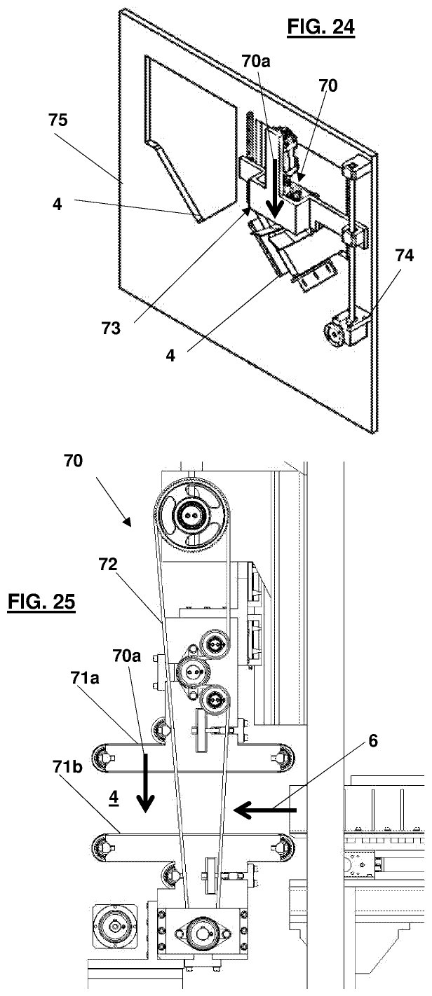

In possible exemplary embodiments according to FIGS. 24 and 25, in the cutting region 2 in the various ways above described, at the cradles 4 an element of pressure 70 can be provided, commonly called presser.

In a possible solution, as shown in FIG. 24, the pressing element 70 comprises an upper pressing member 73 having at least one couple of plane upper pressing plates, configured to contact a respective generatrix of the log (not shown), opposite to the cradle 4. This way, the upper pressing member 73 can carry out a blocking movement 70a in a direction that is orthogonal to the conveying direction, according to a blocking stroke simultaneously to the movement of the cutting portion into the cutting plane. There can be provided a mechanism 74 of adjustment in height of the upper pressing member, which allows both adjusting a rest position of the plane pressing plates and adapting to different diameters of the log, carrying out the stroke of blocking/unlocking the log. Advantageously, as shown in the figure, a pressing device 70 can be provided of a support structure 75 of a plurality of cradles 4 adjacent to each other and relative pressing devices.

In another possible solution, as shown in FIG. 25, the pressing element 70 comprises two conveyor belts 71a, 71b facing each other that move for pushing a log not shown in the conveying direction 6, in order to cause it to advance. Furthermore, the belts 71a, 71b can move in a direction 70a orthogonal to the conveying direction 6, for carrying out a blocking stroke of the log, simultaneously to the movement of the cutting portion of the blade 10 in the cutting plane by it defined. For carrying out the blocking movement in the direction 70a, there can be provided a mechanism of pushing and adjusting in height 72 the conveyor belts 71a, 71b, in order to both adjusting a rest position of the conveyor belts and adapting to different diameters of the log, as well as carrying out the blocking stroke during the movement of the cutting portion of the blade 10. Such a configuration of the clamping device can also be used in case of continuous movement, according to the FIGS. 11-13.

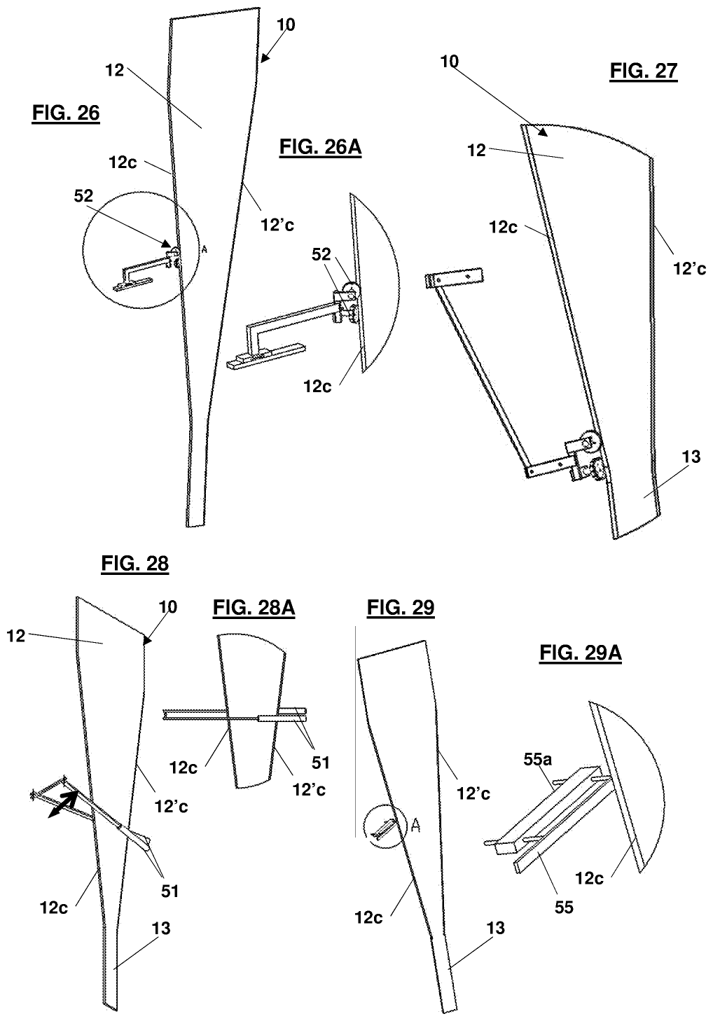

In possible embodiments, according to FIGS. 26-29, a step can be provided of sharpening the blade, carried out only on the cutting profile 12c of the cutting portion and not on the connection portion 13. This determines that portions of the blade are not sharpened, and then easily handled in case of mounting and maintenance.

In particular, the sharpening step can be made through at least one sharpening knob 52 mounted to an oscillating arm 53, configured to oscillate by translating (FIGS. 26,26a) or by rotating (FIG. 27) with respect to a fixed frame, under the push of the knob 52, in order to follow the cutting profile 12c during the movement of the cutting portion 12.

Alternatively, as shown in FIGS. 28 and 28A, the sharpening can be made through a couple of abrasive sharpening sticks 51 arranged slanted and opposite to each other, and configured for closing or widening from each other according to arrow 51a respectively, for carrying out the sharpening of the cutting profile 12c (normally called bevel) or releasing the blade when the sharpening has not to be done.

As further alternative, as shown in FIGS. 29, 29A, the sharpening can be made by an elongated abrasive strip 55 mounted to a support 55a having an approaching movement and arranged laterally so that the cutting profile 12c contacts with an own side face against the strip 55, allowing that different portions of the cutting profile 12c contact different portions of the strip 55.

The foregoing description exemplary embodiments of the invention will so fully reveal the invention according to the conceptual point of view, so that others, by applying current knowledge, will be able to modify and/or adapt for various applications such embodiment without further research and without parting from the invention, and, then it is therefore to be understood that such adaptations and modifications will have to be considered as equivalent to the specific embodiments. The means and the materials to realise the different functions described herein could have a different nature without, for this reason, departing from the field of the invention. It is intended that the expressions or the terminology used have object purely descriptive and, for this, not limitative.

1. A method for cutting logs comprising the steps of:
prearranging at least one cutting region configured to be crossed by at least one log according to a conveying direction transversal to a cutting plane;
prearranging a blade having a longitudinal axis and comprising:
a plane cutting portion and a connection portion connected to said cutting portion; and
said cutting portion having a cross section of minimum width, a cross section of maximum width and at least one cutting profile that extends obliquely between said cross section of minimum width, and said cross section of maximum width so that said cutting profile forms an angle with respect to said longitudinal axis set between 1° and 60°, in particular between 1° and 30°, much more in particular, between 1° and 10°, preferably between 1° and 8°,
said cutting profile having a cutting height in a direction that is orthogonal to said longitudinal axis equal to at least the difference between said cross section of maximum width and said cross section of minimum width, and said connection portion having width less than or equal to said minimum width
moving said blade parallel to said longitudinal axis so that said connection portion and said cutting portion cross in turn said cutting region and said cutting portion passes through said cutting region according to said cutting plane; and
conveying said or each logs on a respective cutting cradle in said cutting region, said or each logs having a height less than said cutting height so that said cutting profile that extends obliquely cuts said logs during said movement starting from a point in which it comes in contact with said log, causing a cut in said logs and obtaining cut portions having a same length as a predetermined conveying length.

2. The method according to claim 1, wherein said blade is selected from the group consisting of:
a blade with said cutting portion having a single cutting profile,
a blade with said cutting portion having two cutting profiles opposite to each other with respect to said longitudinal axis, in said cutting region logs being fed opposite to each other with respect to said longitudinal axis so that respective logs are cut by respective cutting profiles;
a blade with said cutting portion having two cutting profiles arranged at a same side with respect to said longitudinal axis, said two cutting profiles cutting said logs when said blade is moved according to an alternated movement in respective opposite directions; and
a combination thereof.

3. The method according to claim 1, wherein said blade is selected from the group consisting of:
a blade in which said plane cutting portion and said connection portion connected to said cutting portion are consisting of a single plane band, selected from the group consisting of: a band continuously looped about at least two flywheels that provide a continuous movement, a reciprocating band; and
a blade in which said plane cutting portion comprises a plane band and said connection portion is a connecting element connected to said plane cutting portion, and wherein said blade is selected from the group consisting of: a continuous blade looped around about at least two flywheels that provide a continuous movement, a discontinuous blade having reciprocating movement, and wherein said connection portion is selected from the group consisting of: a band portion, a chain portion, a rope portion, a belt portion.

4. The method according to claim 1, wherein said blade comprises a conveying portion having a larger width than said cutting portion, said conveying portion OM-defining at least one elongated hole on which said at least one cutting profile and said connection portion are faced, said elongated hole defined by connection belt that extends opposite to said at least one cutting profile.

5. The method according to claim 4, wherein said plane cutting portion provides a second elongated hole, for lightening, in particular the plane cutting portion provides a band portion that has a first end connected to a first connection belt and a second end that is connected to a second connection belt, the band portion extending obliquely between the first connection belt and the second connection belt, in order to have said cutting profile facing towards the first connection belt.

6. The method according to claim 5, wherein said band portion has also a cutting profile facing towards the second connection belt in case of reciprocating movement of the blade.

7. The method according to claim 1, wherein said conveying is selected from the group consisting of:
a stepped conveying of said or each logs on a respective cutting cradle in said cutting region, said stepped conveying being carried out when in said cutting region said connection portion is moving and being stopped when in said cutting region said cutting portion is moving, so that said cutting profile that extends obliquely cuts said logs obtaining cut portions for a length corresponding to one step; and
a continuous conveying of said or each logs according to a conveying direction on a respective cutting cradle in said cutting region, in said cutting region a conveying device being provided that causes a bending of said blade in said conveying direction between a first position and a second position, said conveying device causing said bending in said conveying direction from said first position to said second position in a way that is synchronous to said continuous conveying of said or each logs when in said cutting region said cutting portion is moving, so that said cutting profile that extends obliquely cuts said logs obtaining cut portions having a same length as a predetermined conveying length, and said conveying device causing said bending in an opposite direction to said conveying direction from said second position to said first position when in said cutting region said connection portion is moving, so that said connection portion moves next to said logs without impeding said continuous conveying of said log.

8. The method according to claim 7, wherein two respective conveying devices are provided, which move integrally in an alternated way, but according to two opposite phases on two opposite sides of said blade causing a bending of the blade according to said conveying direction or in an opposite conveying direction in according to phases opposite to each other, in said bending, the tension of the blade not requiring particular compensations, since said blade is fixedly tensioned.

9. The method according to claim 1, wherein said blade is looped around a plurality of flywheels or pulleys arranged as a polygon, in particular a quadrilateral, wherein, on a side of said polygon a sharpening device is provided, and wherein on at least another side of said polygon at least one cutting region is provided, in particular said cutting region arranged downstream of storage region of logs downstream of a production line of paper material comprising at least one rewinding machine, or an interfolding machine, or a machine for stacking packages of folded sheets, in particular said cutting region being configured in a way selected from the group consisting of:
a cutting region comprising downstream of a downhill conveying path along which cut portions of logs move, wherein a first side of said polygon consisting of said blade crosses said cutting region upstream of said downhill conveying path, and a second side of said polygon consisting of said blade is opposite to said first side and extends above said downhill conveying path so that said blade does not impede said cut portions of log;
a cutting region and a conveying path of logs upstream of said cutting region, wherein a first side of said polygon consisting of said blade crosses said cutting region, and a second side of said polygon consisting of said blade is opposite to said first side and extends upstream of said conveying path so that said blade does not impede logs being cut;
a cutting region and two conveying paths of logs upstream of said cutting region, wherein a first and a second side of said polygon consisting of said blade cross said conveying paths in two respective cutting regions, in order to cut the logs coming from said two conveying paths, and a third side of said polygon consisting of said blade passes above two respective downhill conveying paths so that said blade does not impede respective cut portions of log; and
a cutting region wherein said polygon is arranged in a vertical plane and said blade has at least one couple of cutting profiles opposite to said longitudinal axis, upstream of said cutting region there being provided a conveying path of at least two logs so that said at least two logs are located at opposite sides with respect to said blade in said cutting plane.

10. The method according to claim 1, wherein in said cutting region a pressing element is provided selected from the group consisting of:
a pressing element comprising two conveyor belts facing each other that move in said conveying direction, for carrying out said moving of said logs, and in an orthogonal direction to said conveying direction, for carrying out a blocking stroke of said logs simultaneously to the movement of said cutting portion of said blade in said plane, an adjustment mechanism for adjustment in height of said conveyor belts being provided, in order to adjust a rest position of said conveyor belts before carrying out said blocking stroke and adapting to different diameters of said log; and
a pressing element comprising an upper pressing member having at least one couple of plane upper pressing plates, configured to contact a respective generatrix of said logs above said cradle, said upper pressing member carrying out a blocking movement in a direction orthogonal to said conveying direction according to a blocking stroke of simultaneously to the movement of said cutting portion of said blade in said cutting plane, there being provided an adjustment mechanism in height of said upper pressing member, in order to adjust a rest position of said plane pressing plates before carrying out said blocking stroke of and adapting to different diameters of said log.

11. The method according to claim 1, wherein a sharpening step is provided of said blade, wherein said sharpening step is carried out only on the cutting profile of said cutting portion and is not made on said connection portion, in particular said sharpening step being selected from the group consisting of:
sharpening by a couple of abrasive sharpening sticks arranged slanted and opposite to each other;
sharpening by a sharpening knob mounted to an oscillating arm configured to oscillate under the push of said knob in order to follow and sharpen said cutting profile during the movement of said cutting portion, and sharpening by an elongate abrasive strip mounted to a support arranged laterally so that said cutting profile contacts with an own side face against said strip so that different portions of said cutting profile slide against different portions of said strip.

12. A plant for cutting logs that is configured for carrying out the method according to claim 1.

13. A blade for cutting logs that is configured for carrying out the method according to claim 1.

14. A plant for cutting logs that is configured for carrying out the method according to claim 2.

15. A plant for cutting logs that is configured for carrying out the method according to claim 3.

16. A plant for cutting logs that is configured for carrying out the method according to claim 4.

17. A blade for cutting logs that is configured for carrying out the method according to claim 2.

18. A blade for cutting logs that is configured for carrying out the method according to claim 3.

19. A blade for cutting logs that is configured for carrying out the method according to claim 4.
